(19) United States
(12) Patent Application Publication
(10) Pub. No.: US 2010/0072073 A1
(43) Pub. Date: Mar. 25, 2010

(54) Method for the electrochemically coating or stripping the coating from components

(76) Inventors: Rene Jabado, Berlin (DE); Jens Dahi Jensen, Berlin (DE); Ursus Krüger, Berlin (DE); Daniel Körtvelyessy, Berlin (DE); Volkmar Lüthen, Berlin (DE); Ralph Reiche, Berlin (DE); Michael Rindler, Schoneiche (DE); Raymond Ullrich, Schonwalde (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/441,671

(22) PCT Filed: Sep. 11, 2007
(86) PCT No.: PCT/EP2007/059525

§ 371 Date: Oct. 16, 2009

(30) Foreign Application Priority Data
Sep. 18, 2006 (DE) 10 2006 044 416.7

(51) Int. Cl. C25D 5/00; C25D 5/16; C25D 5/18; C25D 17/12; B23H 3/00; B23H 3/04; F01D 5/14

(52) U.S. Cl. 205/238; 205/80; 205/640; 204/242

(57) ABSTRACT

A method for the electrochemical application or removal of a coating of components (1) is made available, in which the component (1) serves as an electrode and in which, between the component (1) and the counterelectrode (3), an electrical field is built up which leads to the deposition of a coating material dissolved in an electrolyte or to the removal of a coating material (11) located on the component surface (2). During deposition or during removal, the component (1) is covered by structures (5) consisting of an electrically insulating material.

The present invention relates to a method for the application or removal of coatings of components, for example for the application or removal of coatings of turbine components having an MCrAlY coating.

Many sectors of technology cannot be imagined nowadays without the application and removal of coatings of components. Spray processes and electrochemical processes are employed in order to apply or remove a coating. Of especial importance are not only such coatings with specific physical properties, but also coatings having a structured surface. A coating of components of turbomachines which has a structure resembling that of a sharkskin may be mentioned as an example here. A structure of this type has scales which are in each case provided in turn with grooves. However, because of the fine structures in their surface, coatings of this type can be produced only at a high outlay. Production often takes place by spray methods, using suitable stencils or masks. However, spray methods allow only the additive production of structured surfaces, that is to say the production of a structure by the additional application of material at specific locations on the surface.

The object of the present invention, therefore, is to make available an alternative method for the production of a coating having a structured surface, which method, in particular, also makes it possible to produce a structure in the coating surface by the removal of material.

This object is achieved by means of a method for the electrochemical application or removal of coatings of components, such as is defined in claim 1. The dependent claims contain advantageous refinements of the method according to the invention.

In the method according to the invention for the electrochemical application or removal of coatings of components, the component serves as an electrode. Between the component and a counterelectrode, an electrical field is built up which leads to the deposition of a coating material dissolved in an electrolyte or to the removal of a coating material located on the component surface. In the method according to the invention, during deposition or during removal, the component is covered by structures consisting of an electrically insulating material.

The electrically insulating structures exert a shielding effect on the surface of the component, the result of which is that the electrical field on the surface of the component is lower in the region of the structures than between the structures. Depending on the polarity of the electrical field, therefore, more material is deposited on surface regions lying between the insulating structures than on surface regions covered by the structures. With a reversed polarity of the electrical field, more coating material is removed in regions between the structures than in regions which are covered by the structures. Since the structures may have very small dimensions, they make it possible to generate surface structures with very small dimensions, for example very fine grooves or very fine burrs, on the coating surface. In particular, the method according to the invention makes it possible, by the removal of coating material, subsequently to introduce a surface structure into the surface of a planar coating surface already applied to a component.

The structures consisting of electrically insulating material may be, for example, threads which are connected to one another in the form of a net. The surface structure of the coating may in this case be predetermined by the type of interlinking of the threads, that is to say by the structure of the net.

The deposition or removal of coating material may take place, using a continuously prevailing electrical field or else using a pulsed electrical field, that is to say an electrical field which is built up and broken down again in successive pulses.

In a development of the method according to the invention, the counterelectrode used is a structured electrode. The structuring may be implemented, for example, in the form of burrs on the electrode surface. The structured electrode is used such that the structures project in the direction of the component which has the coating to be applied or removed. By means of the structure of the counterelectrode, the flux line density of the electrical field on a component surface can be influenced. For example, in the region of burrs, a flux line density in the region of the component surface is higher than between the burrs. As a rule, however, the structure of the counterelectrode cannot be produced as finely as, for example, the threads of the net already mentioned. The use of a structured counterelectrode is therefore advantageous particularly when the coating surface is to have surface structures having coarse-scale dimensions. Mention may be made here, for example, of the structure resembling that of a sharkskin, already mentioned in the description introduction, in which a coarse-scale surface structure, to be precise the scales, is present, which is superposed by a fine-scale surface structure, to be precise the grooves in the scales. The coarse-scale structure and the fine-scale structure may be produced simultaneously or in succession. If, however, only a coarse-scale structure, for example scales without grooves, is to be generated in the coating on the component, the structured counterelectrode may also be used alone, that is to say without the structure consisting of electrically insulating material.

To produce a coating surface resembling that of a sharkskin, the shape of the structures of the counterelectrode and the spacings between them may be selected such that a scale structure is formed in the coating located on the surface of the component. In other words, the structuring of the counterelectrode constitutes the inverse structure to the coarse-scale structure to be generated in the coating surface. At the same time, the orientation of the electrically insulating threads and the spacings between them can be selected in relation to one another such that, during the deposition or removal of the coating material, grooves are formed in the individual scales of the scale structure. The resulting structure in the coating surface is a structure resembling that of a sharkskin. It is also possible, however, to produce a structure resembling that of a sharkskin solely by means of electrically insulating threads, in which case these form, for example, a net in which fine-scale structures are superposed on coarse-scale structures. In particular, threads of different thickness may be used in a net of this type.

In a method according to the invention, in particular, a counterelectrode may be employed which is adapted in shape to the shape of the component. A constant spacing between the average electrode surface and the component surface can thereby be implemented.

In the method according to the invention, in particular, an MCrAlX material, as it is known, may be employed as coating material, and a component of a turbo machine, for example a moving blade or guide vane of a gas turbine, may be employed as the component having a coating to be applied or to be removed. An MCrAlX material is an alloy material in which M stands for a metal, in particular cobalt (Co) or nickel (Ni) and X stands for a rare earth element or hafnium (Hf) or silicon (Si) or yttrium (Y). Such materials are employed as oxidation-inhibiting/corrosion-inhibiting coatings in turbomachines, such as, for example, gas turbines.

Further features, properties and advantages of the present invention may be gathered from the following description of an exemplary embodiment, with reference to the accompanying figures.

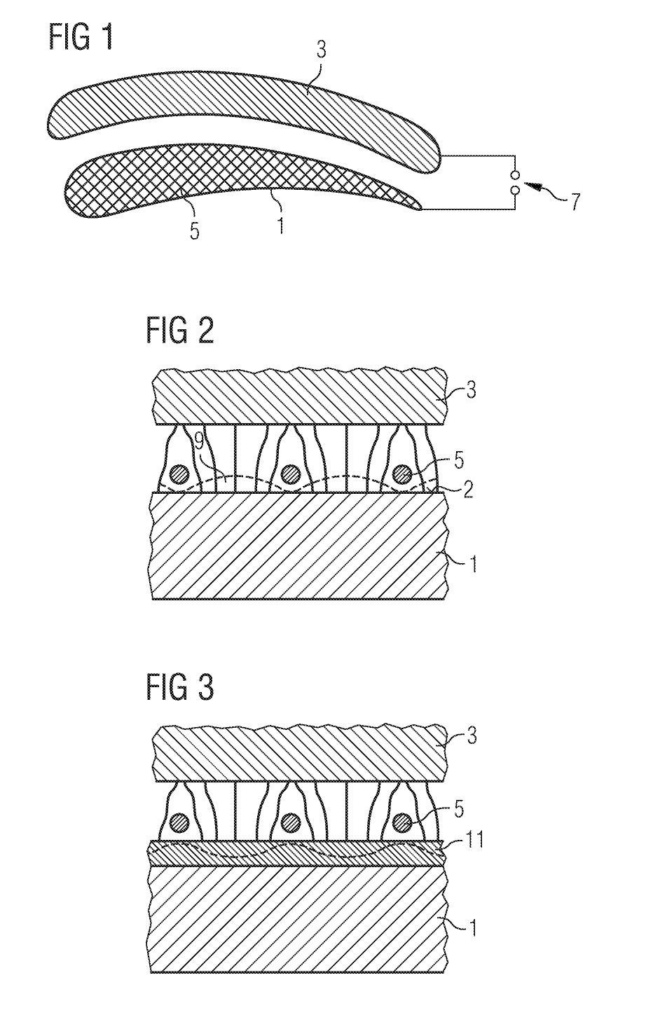

FIG. 1 shows, highly diagrammatically, the arrangement of a component, of a counterelectrode and of electrically insulating threads in carrying out the method according to the invention.

FIG. 2 shows the flux line distribution between the component and the counterelectrode during the application of a coating.

FIG. 3 shows the flux line distribution between the component and counterelectrode during the removal of a coating.

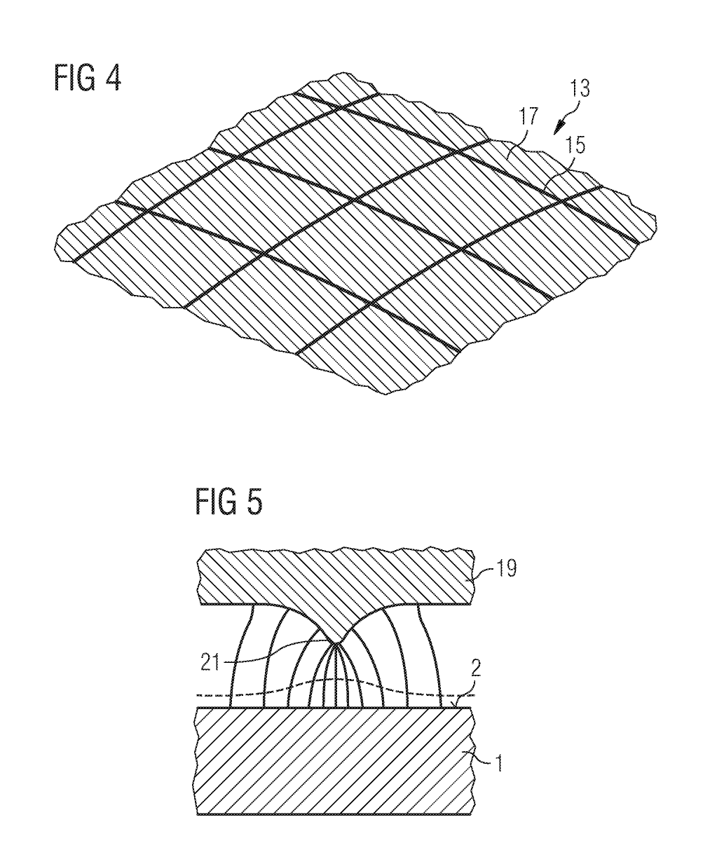

FIG. 4 shows a net consisting of electrically insulating threads which can be used in the method according to the invention.

FIG. 5 shows the application of a coating of a component, using a structured counterelectrode.

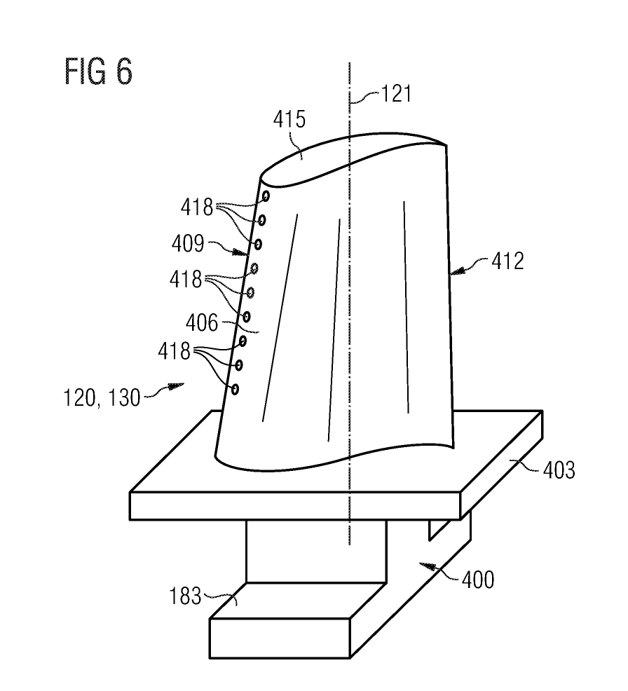

FIG. 6 shows a moving blade or guide vane of a gas turbine.

The arrangement of a component 1, which has a coating to be applied or to be removed and which serves as an electrode in the coating application or coating removal method, and of a counterelectrode 3 to the component 1 is illustrated in FIG. 1. The component 1 is covered with a net 5 which consists of electrically non-conductive threads and which constitutes a structure consisting of electrically insulating material. The electrode 1 and the counterelectrode 3 are connected to opposite poles of a voltage source 7, so as to form between the electrode 1 and the counterelectrode 3 a potential difference which leads to the formation of an electrical field between the two.

Both the component 1 and the counterelectrode 3 are located, during the application or removal of the coating, in an electrolyte which is not illustrated in FIG. 1 for the sake of clarity. The electroplating bath comprises an electrolyte, in which either a coating material to be applied is dissolved or which can dissolve a coating material located on the component 1. By means of the electrical field formed between the component 1 and the counterelectrode 3, coating material 9 dissolved in the electrolyte can then be deposited onto the surface of the component 1 in order to coat the component 1 (see FIG. 2). If a removal of parts of a coating 11 already located on the component 1 is to take place by means of the method (cf. FIG. 3), coating material is dissolved from the coating 11 by means of the electrolyte. The prevailing electrical field then ensures that the ions dissolved in the electrolyte are transported away from the surface of the component 1.

In both instances, the threads consisting of electrically non-conductive material, that is to say of a dielectric, ensure that the flux line density between the threads is increased and that in the region of the threads is reduced correspondingly. During the application of a coating, the result of this is that more material is applied between the threads 5 than beneath the threads (see FIG. 2). When a coating is being removed, by contrast, the result of this is that more material is removed between the threads than beneath the threads (see FIG. 3).

Thus, with the aid of the electrically insulating threads, a surface structure can be produced in a coating on the component 1. In particular, this can take place both when the coating is being applied and when a coating is being removed. This, in particular, affords the possibility of providing already coated parts subsequently with a surface structure by means of the partial removal of the coating.

A net 13 which is suitable as a structure consisting of electrically insulating material, in particular for the production of a surface structure resembling that of a sharkskin, is illustrated in FIG. 4. The net comprises first threads 15 which form a relatively coarse-mesh net. Furthermore, second threads 17 are present, which have a relatively small spacing from one another and run diagonally with respect to the first threads 15. When a coating is being applied or removed, the first threads 15 then lead to the formation of the coarse-scale scale structure, whereas the second threads 17 lead to the formation of grooves in the scales. The first and second threads 15 and 17 may in this case, in particular, also have different diameters. In the net 13, the first threads 15 which form the coarse-scale net have a spacing from one another which lies in the range of 10 to 100 μm. By contrast, the second threads 17 for forming the fine-scale structure in the coating have a spacing from one another which is markedly lower than 10 μm and, in particular, lies in the range of 0.1 to 2 μm.

An alternative possibility for the production, in particular, of the coarse-scale structures is illustrated in FIG. 5 which shows a component 1 and a counterelectrode 19. The counterelectrode illustrated in FIG. 5 has a structured electrode surface, in contrast to the counterelectrode 3 from FIGS. 1 to 3. The structuring is implemented by means of burrs 21 which project above the actual electrode surface. To apply or remove a coating of the component 1, the counter electrode 19 is oriented with respect to the component 1 such that the burrs 21 point in the direction of the component 1. When the voltage is applied between the component 1 and the counterelectrode 19, the flux line density is increased in the region of the burr 21, as compared with the remaining regions of the counterelectrode 19, this also leading to an increase in the flux line density in the region of the component 1, insofar as the counterelectrode 19 is not too far away from the component surface.

On account of the increased flux line density, the rate at which coating material is applied or removed is increased in those regions of the component which lie opposite the burrs 21. The deposition of coating material 9 is illustrated in FIG. 5. However, material on the coating already located in the component 1 may also be removed.

To produce a structure resembling that of a sharkskin, the burrs 21 may be arranged in diamond form on the surface of the counterelectrode 19. Adjacent burrs are then at a spacing of approximately 10 to 100 μm from one another. With the aid of the burrs 21, scale-like structures can then be generated in a coating to be applied to the component 1 or are already present on the latter. By means of a net which is additionally arranged above the component 1 and which has only the fine threads 17 from FIG. 4 and is arranged with a suitable orientation above the component surface 1, the grooves can be produced in the scales. In this design variant, therefore, the coating having a surface structure resembling that of a sharkskin is produced with the aid of the combination of a structured counterelectrode 19 and the use of electrically non-conducting threads 5. Insofar as only the coarse-scale structure is to be produced, however, the net may even be dispensed with. The production of the coarse-scale scale structure in this case does not necessarily need to take place simultaneously with the production of the fine-scale groove structure. It is also possible first to generate the two structures and thereafter to form the other structure in the prestructured surface.

When a structured counterelectrode 19 is used, it is possible, via the spacing of the latter from the component surface 2, to set how diffuse the structure in the surface of the coating is to be. The further the counterelectrode is away from the surface 2 of the component 1, the lower is the effect of the increased flux line density in the region of the burrs 21 on the surface 2 of the component 1. In other words, the further the counterelectrode is away from the component 1, the more uniform the flux line density in the region of the component surface is and the more diffuse the surface structure generated becomes.

The method described may be employed, in particular, for producing a coating having a structured surface on components of turbomachines. In particular, the method is suitable for applying an MCrAlX coating to moving blades or guide vanes, such as are described below with reference to FIG. 6.

FIG. 6 shows a perspective view of a moving blade 120 or guide vane 130 of a turbomachine which extends along a longitudinal axis 121.

The turbomachine may be a gas turbine of an aircraft or of a power station for electricity generation, a steam turbine or a compressor.

The blade 120, 130 has successively along the longitudinal axis 121 a fastening region 400, a blade platform 403 contiguous to the latter, and also a blade leaf 406 and a blade tip 415. As a guide vane 130, the blade 130 may have (not illustrated) a further platform at its blade tip 415.

In the fastening region 400, a blade root 183 is formed, which serves (not illustrated) for fastening the moving blades 120, 130 to a shaft or a disk. The blade root 183 is configured, for example, as a hammerhead. Other configurations as a pinetree or dovetail root are possible. The blade 120, 130 has a leading edge 409 and a trailing edge 412 for a medium which flows past the blade leaf 406.

In conventional blades 120, 130, for example, solid metallic materials, in particular superalloys, are used in all regions 400, 403, 406 of the blade 120, 130. Such superalloys are known, for example, from EP 1 204 776 B1, EP 1 306 454, EP 1 319 729 A1, WO 99/67435 or WO 00/44949; these publications are part of the disclosure in respect to the chemical composition of the alloy. The blade 120, 130 may in this case be manufactured by means of the casting method, also by means of directional solidification, by means of a forging method, a milling method or combinations of these.

Workpieces with a monocrystalline structure or structures are used as components for machines which are exposed during operation to high mechanical, thermal and/or chemical loads. The manufacture of monocrystalline workpieces of this type takes place, for example, by directional solidification from the melt. This involves casting methods in which the liquid metallic alloy solidifies into the monocrystalline structure, that is to say into the monocrystalline workpiece, or directionally. In this case, dendritic crystals are oriented along the heat flow and form either a columnar-crystalline grain structure (columnar, that is to say grains which Turnover the entire length of the workpiece and here, according to general linguistic practice, are designated as being directionally solidified) or a monocrystalline structure, that is to say the entire workpiece consists of a single crystal. In these methods, the transition to globulitic (polycrystalline) solidification must be avoided, since undirected growth necessarily results in transverse and longitudinal grain boundaries which nullify the good properties of the directionally solidified or monocrystalline component. When directionally solidified structures are referred to in general, this means both monocrystals which have no grain boundaries or, at most, low-angle grain boundaries and columnar-crystal structures which indeed have grain boundaries running in the longitudinal direction, but no transverse grain boundaries. Where these second-mentioned crystalline structures are concerned, directionally solidified structures are also referred to. Such methods are known from U.S. Pat. No. 6,024,792 and EP 0 892 090 A1; these publications are part of the disclosure in respect of the solidification method.

The blades 120, 130 may likewise have coatings against corrosion or oxidation, for example (MCrAlX; M is at least one element of the group iron (Fe), cobalt (Co), Nickel (Ni), X is an active element and stands for yttrium (Y) and/or silicon and/or at least one rare earth element or hafnium (Hf)). Such alloys are known from EP 0 486 489 B1, EP 0 786 017 B1, EP 0 412 397 B1 or EP 1 306 454 A1 which are to be part of the disclosure in respect of the chemical composition of the alloy. The density preferably lies at 95% of theoretical density. A protective aluminum oxide layer (TGO=thermal grown oxide layer) is formed on the MCrAlX layer (as an intermediate layer or as an outermost layer).

On the MCrAlX, a heat insulation layer may also be present, which is preferably the outermost layer and consists, for example of ZrO2, Y2O3-ZrO2, that is to say it is not or is partially or completely stabilized by yttrium oxide and/or calcium oxide and/or magnesium oxide. The heat insulation layer covers the entire MCrAlX layer. By means of suitable coating methods, such as, for example, electron beam vapor deposition (EB-PVD), columnar grains are generated in the heat insulation layer. Other coating methods may be envisaged, for example atmospheric plasma spraying (APS), LPPS, VPS or CVD. The heat insulation layer may have porous, microcrack- or macrocrack-compatible grains for better thermal shock resistance. The heat insulation layer is therefore preferably more porous than the MCrAlX layer.

Refurbishment means that components 120, 130, after being used, must, where appropriate, be freed of protective layers (for example, by sandblasting). A removal of the corrosion layers or products and/or oxidation layers or products then takes place.

If appropriate, cracks in the component 120, 130 are also repaired. This is followed by a recoating of the component 120, 130 and a renewed use of the component 120, 130.

The blade 120, 130 may be of hollow or solid form. If the blade 120, 130 is to be cooled, it is hollow and also has, if appropriate, film cooling holes 418 (indicated by dashes).

The invention described in the exemplary embodiments makes it possible to produce coatings having a structured surface with the aid of electrochemical deposition or etching methods. It therefore allows not only the additive production of a structured surface, but also the structuring of a coating surface already present by means of the partial removal of the coating.

1. A method for the electrochemical application or removal of a coating of components, in which the component serves as an electrode, the method comprises the step of:
Building up an electrical field between the component and a counterelectrode which leads to the deposition of a coating material dissolved in an electrolyte or to the removal of a coating material located on the component surface, wherein during deposition or during removal the component being covered by structures consisting of an electrically insulating material, the structures comprising threads which are arranged in the form of a net around the component, and wherein a structured electrode is used as the counterelectrode in such a way that the structures of the structured electrode project in the direction of the component.

2. The method as claimed in according to claim 1, wherein the electrical field is built up and broken down again in successive pulses.

3. The method according to claim 1, wherein the structures used in the counterelectrode are burrs in the electrode surface.

4. The method according to claim 3, wherein the shape of the structures of the counterelectrode and the spacings between them are selected such that, when the coating material is being deposited or removed, a scale structure is formed in the coating material located on the surface in the component, and wherein the orientation of the electrically insulating threads and the spacings between them are selected in relation to one another such that, when the coating material is being deposited or removed, grooves are formed in the individual scales of the scale structure.

5. The method according to claim 1, wherein the counterelectrode used is an electrode adapted in shape to the shape of the component.

6. The method according to claim 1, wherein the coating material used is an MCrAlX material and the component used is a turbine component.

7. A system for the electrochemical application or removal of a coating of components, in which the component serves as an electrode, further comprising means for building up an electrical field between the component and a counterelectrode which leads to the deposition of a coating material dissolved in an electrolyte or to the removal of a coating material located on the component surface, wherein during deposition or during removal the component being covered by structures consisting of an electrically insulating material, the structures comprising threads which are arranged in the form of a net around the component, and wherein a structured electrode is used as the counterelectrode in such a way that the structures of the structured electrode project in the direction of the component.

8. The system according to claim 7, wherein the electrical field is built up and broken down again in successive pulses.

9. The system according to claim 7, wherein the structures used in the counterelectrode are burrs in the electrode surface.

10. The system according to claim 9, wherein the shape of the structures of the counterelectrode and the spacings between them are selected such that, when the coating material is being deposited or removed, a scale structure is formed in the coating material located on the surface in the component, and wherein the orientation of the electrically insulating threads and the spacings between them are selected in relation to one another such that, when the coating material is being deposited or removed, grooves are formed in the individual scales of the scale structure.

11. The system according to claim 7, wherein the counterelectrode used is an electrode adapted in shape to the shape of the component.

12. The system according to claim 7, wherein the coating material used is an MCrAlX material and the component used is a turbine component.
